(19) United States
(12) Patent Application Publication
(10) Pub. No.: US 2024/0202711 A1
(43) Pub. Date: Jun. 20, 2024

(54) DECENTRALIZED INCENTIVE SYSTEM FOR VALIDATING TRANSACTIONS TO BLOCKCHAIN MINERS

(71) Applicant: PayPal, Inc., San Jose, CA (US)

(72) Inventor: Sujay Vijay Purandare, Portland, OR (US)

(21) Appl. No.: 18/535,653

(22) Filed: Dec. 11, 2023

Related U.S. Application Data
(60) Provisional application No. 63/433,190, filed on Dec. 16, 2022.

(51) Int. Cl. G06Q 20/36; H04L 9/30

(52) U.S. Cl. CPC G06Q 20/3678; H04L 9/30

(57) ABSTRACT

Methods and systems that may incentivize miners to mine transactions are provided. A verification system may broadcast a transaction request, that includes an on-chain transaction to be mined on a block of the blockchain network. The verification system may generate a smart contract for incentivizing the transaction. A smart contract may receive a message confirming that the transaction has been mined on the block of the blockchain network. The smart contract may query, via an oracle, the mined block containing the transaction from the blockchain network. The smart contract may determine whether the hash of the transaction on the mined block matches the hash in the message. The smart contract may determine whether a key of the miner matches a list of incentivized keys stored on the smart contract and release an incentive to the miner.

### CROSS-REFERENCE TO RELATED APPLICATIONS

This application claims priority to U.S. Provisional Patent Application No. 63/433,190, filed on Dec. 16, 2022, which is incorporated by reference in its entirety.

### TECHNICAL FIELD

The disclosure relates generally to digital assets, and more specifically to a decentralized incentive mechanism for validating blockchain mining transactions.

### BACKGROUND

Entities may utilize online electronic transaction processors to process transactions between entities as well as exchange and transfer funds. This may include transactions on digital marketplaces and the like. Digital marketplaces may include e-commerce platforms, virtual marketplaces in games, marketplaces in a virtual environment such as a metaverse, etc. Entities may transact in these digital marketplaces using various assets, such as money in a traditional bank account, digital assets including cryptocurrency, non-fungible tokens (NFTs), and other digital assets. Some digital assets may be built on a cryptographic platform, such as a distributed ledger (e.g., Blockchain, Ethereum) that allows purchase, sale, and transfer of the digital assets. Entities or digital marketplace participants may store digital assets in digital wallets.

Entities may engage in transactions, such as an offer for sale, purchase, and/or transfer of digital assets in the digital marketplace. The digital marketplaces conduct transactions using public ledgers, that are mined on a blockchain network. For example, the entities may engage in transactions that use a miner to transfer digital assets to the address of the receiver of the digital assets on the digital marketplace. In an example, a digital asset may be a bitcoin.

Blockchain miners work on the basis of incentives that are released when a block is mined. The incentives may be processing power, time it takes the blockchain miners to mine a block to a blockchain, and the like. This incentivizes miners to use energy resources that may be cheaper, but which may not be environmentally friendly.

### BRIEF DESCRIPTION OF THE DRAWINGS

The accompanying drawings, which are included to provide further understanding and are incorporated in and constitute a part of this specification, illustrate disclosed embodiments and, together with the description, serve to explain the principles of the disclosed embodiments. In the drawings:

FIG. 1 illustrates an exemplary computing environment for facilitating transactions on an example blockchain network, according to an embodiment.

FIG. 2 illustrates an environment of an exemplary distributed ledger network, according to an embodiment.

FIG. 3 illustrates a block diagram of an exemplary distributed ledger, according to an embodiment.

FIG. 4 illustrates a block diagram of an exemplary transaction message, according to an embodiment.

FIG. 5 illustrates a block diagram of an exemplary transaction broadcast on the distributed ledger network, according to an embodiment.

FIG. 6 illustrates a flowchart of a method for performing a smart contract transaction, according to an embodiment.

FIG. 7 is a block diagram of an environment that provides decentralized incentives for a green miner using a smart contract, according to an embodiment.

FIG. 8 is a flowchart of a method for decentralized incentivizing a miner for a blockchain transaction, according to an embodiment.

FIG. 9 illustrates a block diagram of a computer system suitable for implementing one or more components and methods of FIGS. 1-8, according to an embodiment.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized, and structural and functional modifications may be made, without departing from the scope described herein. Various aspects are capable of other embodiments and of being practiced or being carried out in various different ways.

A distributed ledger, such as a blockchain, refers to a framework that supports a trusted ledger that is stored, maintained, and updated in a distributed manner in a peer-to-peer network. For example, in a cryptocurrency application, such as Bitcoin or Ethereum, Ripple, Dash, Litecoin, Dogecoin, zCash, Tether, Bitcoin Cash, Cardano, Stellar, EOS, NEO, NEM, Bitshares, Decred, Augur, Komodo, PIVX, Waves, Steem, Monero, Golem, Stratis, Bytecoin, Ardor, or in digital currency exchanges, such as Coinbase, Kraken, CEX.IO, Shapeshift, Poloniex, Bitstamp, Coinmama, Bisq, Local Bitcoins, Gemini and others, the distributed ledger represents each transaction where units of cryptocurrency are transferred between entities. Using a digital currency exchange, an entity may buy any value of digital currency or exchange any holdings in digital currencies into worldwide currency or other digital currencies. Each transaction can be verified by the distributed ledger and only verified transactions are added to the distributed ledger. The distributed ledger, along with many aspects of a blockchain, may be decentralized. Because of this, the accuracy and integrity of the ledger cannot be attacked at a single, central location. Modifying the distributed ledger at all, or at a majority of locations where it is stored, is difficult so as to protect the integrity of the distributed ledger. This is because individuals associated with the nodes of a peer-to-peer network that stores the distributed ledger have a vested interest in the accuracy of the ledger.

Though maintaining cryptocurrency transactions in the distributed ledger may be the most recognizable use of blockchain technology today, the distributed ledger may be used in a variety of different fields. Indeed, blockchain technology is applicable to any application where data of any type may be accessed.

In some embodiments described herein, a verification system may incentivize certain miners to pick up transactions from the verification system for mining. For example, the verification system may incentivize miners that use a favorable mix of green energy to generate a block. Green energy may be energy collected from renewable resources, such as sunlight, wind, water movement, geothermal heat, and the like. A favorable mix of green energy may be a combination of certain types of green energy, a percentage of green energy compared to other types of resources, or a predefined amount of green energy that may be used to mine a block on a blockchain.

The verification system may be decentralized via a smart contract that includes the incentives, the identities of the incentivized miners, verification that the transaction from the verification system was broadcast to the blockchain network and automatic release of the incentive from the smart contract based on the verification.

Implementations of the disclosure will now be described in detail with reference to the accompanying figures. It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

### Computing Architecture

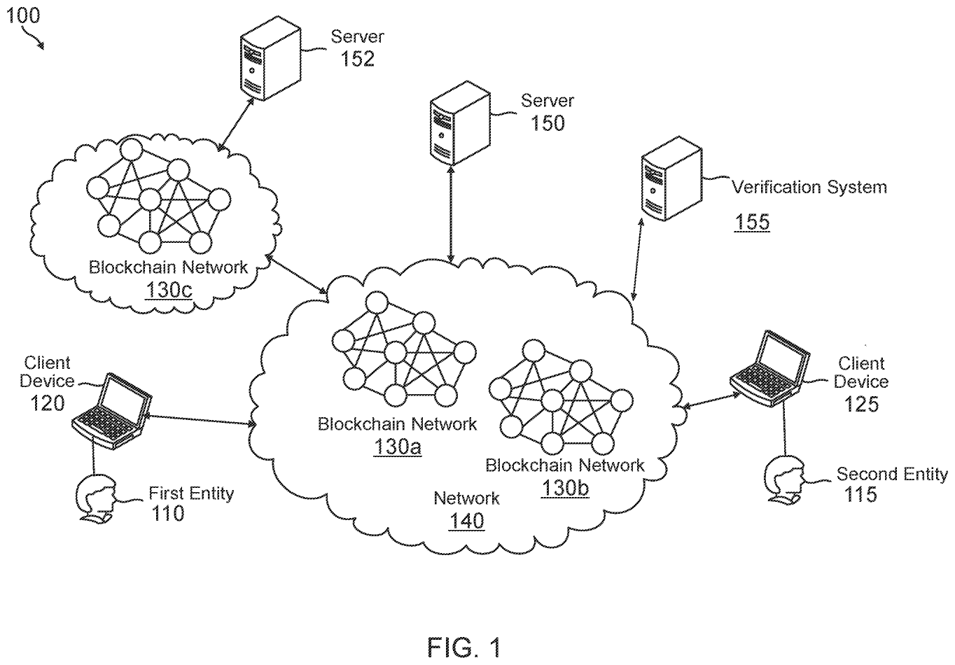

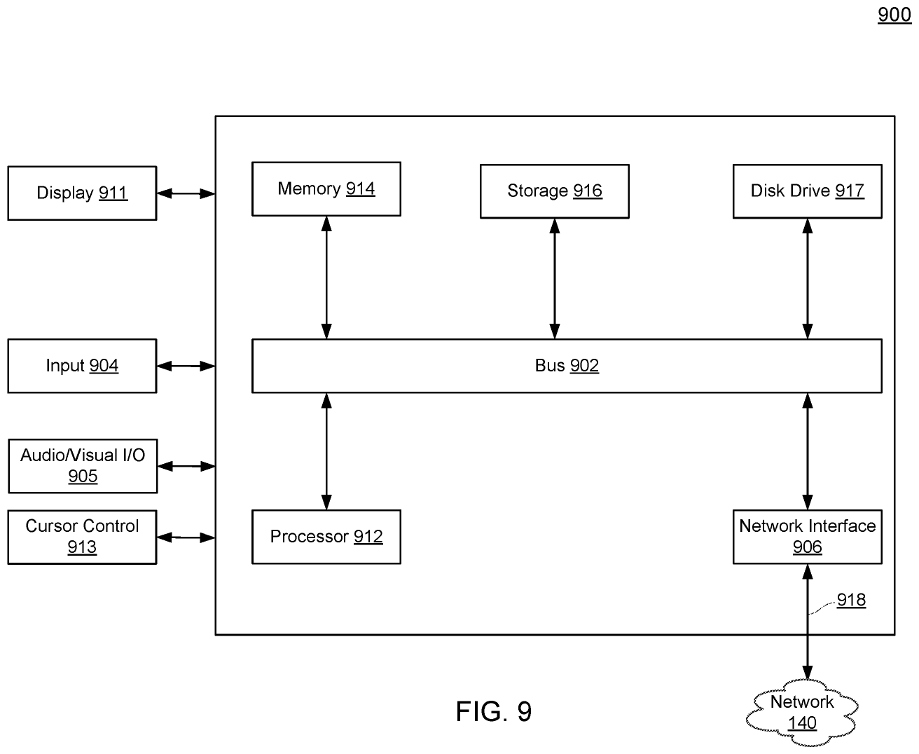

As discussed above, the distributed ledger in a blockchain framework is stored, maintained, and updated in a peer-to-peer network, where the distributed ledger maintains a number of blockchain transactions. FIG. 1 illustrates an exemplary computing environment 100 for facilitating transactions on an example blockchain network, according to an embodiment. The computing environment 100 includes a client device 120 associated with first entity 110, a client device 125 associated with second entity 115, a first server 150, a second server 152, and a verification system 155 interconnected via a network 140. The client device 120, the client device 125, the first server 150, and/or the second server 152 may operate using components of an example computing system 900 described in more detail in FIG. 9. Further, client devices 120 or 125 may include a personal computer, a laptop computer, a smartphone, a personal data assistant (PDA), etc. The verification system 155 may be configured to connect and exchange data between client device 120, client device 125 and blockchain networks 130a-b via the network 140. The network 140 may be any of a variety of available networks, such as the Internet, and represents a worldwide collection of networks and gateways to support communications between devices connected to the network 140.

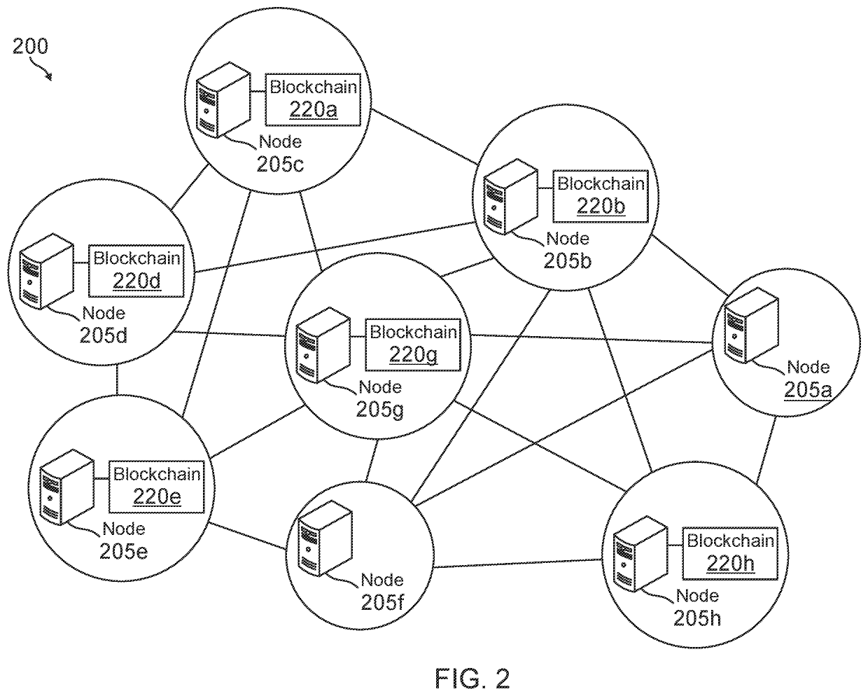

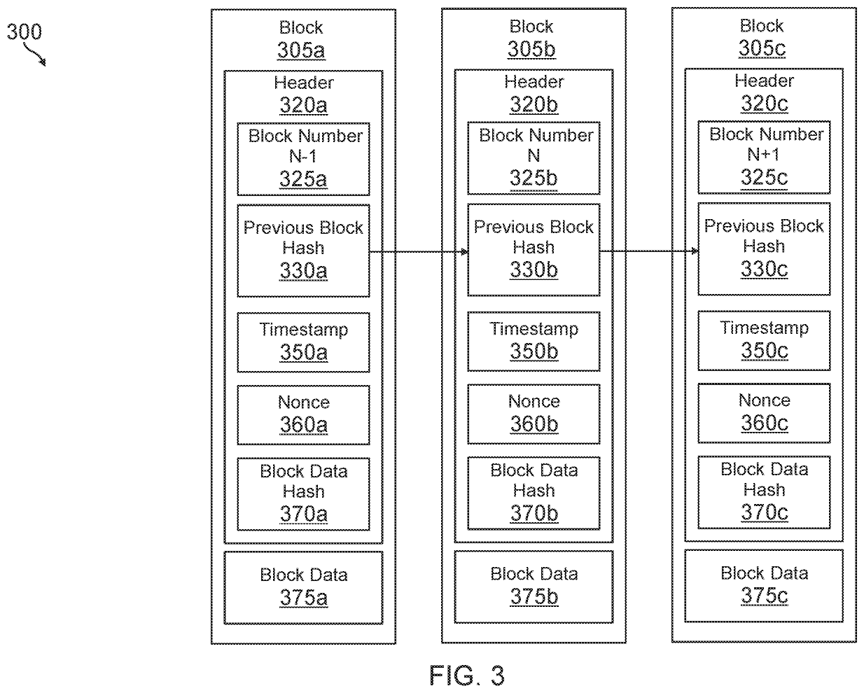

Computing environment 100 may also comprise one or more distributed or peer-to-peer (P2P) networks, such as a first, second, and third blockchain networks 130a-c (generally referred to as blockchain networks 130). As shown in FIG. 1, the network 140 may comprise the first and second blockchain networks 130a and 130b. The third blockchain network 130c may be associated with a private blockchain, and is connected to one or more servers, such as the first server 150, and is thus, shown separately from the first and second blockchain networks 130a and 103b. Each blockchain network 130 may comprise a plurality of interconnected devices (or nodes) as described in more detail with reference to FIG. 2. As discussed above, a blockchain, which may also be referred to as a ledger, is a distributed database for maintaining a growing list of records comprising any type of information. A blockchain, as described in more detail with reference to FIG. 3, may be stored at least at multiple nodes (or devices) of the one or more blockchain networks 130.

In one example, a blockchain based transaction may generally involve a transfer of data or value between entities, such as first entity 110 of the client device 120 and the second entity 115 of the client device 125 in FIG. 1 or uploading data to blockchain network 130 by client devices 120, 125 of one of entities 110, 115. In a non-limiting embodiment, the first entity 110 and the second entity 115 may be users, merchants, subscribers, institutions, other devices, etc., capable of operating on the client device 120 and the client device 125. Each of the servers 150 and 152 may include one or more applications, for example, a transaction application configured to facilitate the transaction between the entities by utilizing a blockchain associated with one of the blockchain networks 130. As an example, the first entity 110 may request or initiate a transaction with the second entity 115 via an application executing on the client device 120. The transaction may be related to a transfer of value or data from the first entity 110 to the second entity 115. The client device 120 may send a request of the transaction to the first server 150. The first server 150 and/or the second server 152 may send the requested transaction to one of the blockchain networks 130 to be validated and approved as discussed below. In another example, first entity 110 may upload a transaction that is associated with a record of data to blockchain network 130 via first server 150 and/or second server 152.

In some embodiments, verification system 155 may facilitate transactions of digital assets on a distributed ledger by broadcasting transaction requests that are sent to miners on the blockchain network 130a or 130b. Verification system 155 may facilitate the first entity 110 to create an authentication mechanism for a digital asset. Verification system 155 may broadcast a transaction request, wherein the transaction request includes an on-chain transaction to be mined on a new block of the blockchain network 130a or 130b. Verification system 155 may generate a smart contract for incentivizing the transaction request. A smart contract may receive a message directed to a smart contract confirming that the transaction request has been mined. The smart contract may query, via an oracle, the mined block containing the transaction from the blockchain network 130a or 130b. In an example, an oracle may be an application programming interface that is an interface between the smart contract and an external world, such as environment 100. An oracle may be used to receive information and content, such as stocks, weather, contents of another blockchain or the like. Notably, application programming interfaces other than an oracle may interface between the smart contract and environment 100. The smart contract may determine whether the hash of the transaction on the mined block matches the hash in the message. The smart contract may determine whether the public key of the miner matches a list of incentivized public keys stored on the smart contract and release via the smart contract one or more incentives to the miner.

### Blockchain Network

FIG. 2 is a diagram of an example blockchain network 200 comprising a plurality of interconnected nodes or devices 205a-h (generally referred to as nodes 205). Blockchain networks 130a-c discussed in FIG. 1 may be implemented as blockchain network 200. Each of the nodes 205 may comprise a computing system 900 described in more detail with reference to FIG. 9. Although FIG. 2 shows a single device for each node 205, each of the nodes 205 may comprise a plurality of devices (e.g., a pool). The blockchain network 200 may be associated with one or more blockchains 220a-h (generally referred to as blockchain 220). Some or all of the nodes 205 may replicate and save an identical copy of the blockchain 220. For example, FIG. 2 shows that the nodes 205b-e and 205g-h store copies of the blockchains 220 b-e and 200 g-h. The nodes 205b-e and 205g-h may independently update their respective copies of the blockchain 220 as discussed below.

### Blockchain Node Types

Blockchain nodes 205, may be full nodes or lightweight nodes. Full nodes, such as the nodes 205b-e and 205g-h, may act as a server in the blockchain network 200 by storing a copy of the entire blockchain 220 and ensuring that transactions posted to the blockchain 220 are valid. The full nodes 205b-e and 205g-h may publish new blocks on the blockchain 220. Lightweight nodes, such as the nodes 205a and 205f, may have fewer computing resources than full nodes. For example, Internet-of-Things (IOT) devices often act as lightweight nodes. The lightweight nodes 205a and 205f may communicate with other nodes 205a-h, provide the full nodes 205b-e and 205g-h with information, and query the status of a block of the blockchain 220 stored by the full nodes 205b-e and 205g-h. In the example, shown in FIG. 2, the lightweight nodes 205a and 205f may not store a copy of the blockchain 220 and thus, may not publish new blocks on the blockchain 220.

### Blockchain Network Types

The blockchain network 200 and its associated blockchain 220 may be public (permissionless), federated or consortium, or private. If the blockchain network 200 is public, then any entity may read and write to the associated blockchain 220. However, the blockchain network 200 and its associated blockchain 220 may be federated or consortium if controlled by a single entity or organization. Further, any of the nodes 205 with access to the Internet may be restricted from participating in the verification of transactions on the blockchain 220. The blockchain network 200 and its associated blockchain 220 may be private (permissioned) if access to the blockchain network 200 and the blockchain 220 is restricted to specific authorized entities, for example organizations or groups of individuals. Moreover, read permissions for the blockchain 220 may be public or restricted while write permissions may be restricted to a controlling or authorized entity.

### Blockchain

FIG. 3 is a block diagram illustrating an example blockchain 300. Blockchain 300 may be one of blockchains 220 discussed in FIG. 2. Blockchain 300 may comprise a plurality of blocks 305a, 305b, and 305c (generally referred to as blocks 305). Blockchain 300 comprises a first block (not shown), sometimes referred to as the genesis block. Each of blocks 305 may comprise a record of one or a plurality of submitted and validated transactions. Blocks 305 of blockchain 300 may be linked together and cryptographically secured. In some cases, the post-quantum cryptographic algorithms that dynamically vary over time may be utilized to mitigate ability of quantum computing to break present cryptographic schemes. Examples of the various types of data fields stored in a blockchain block are provided below. A copy of the blockchain 300 may be stored locally, in the cloud, on grid, for example by the nodes 205b-e and 205g-h discussed in FIG. 2, as a file or in a database.

### Blocks

Each of blocks 305 may comprise one or more data fields. The organization of the blocks 305 within the blockchain 300 and the corresponding data fields may be implementation specific. As an example, the blocks 305 may comprise a respective header 320a, 320b, and 320c (generally referred to as headers 320) and block data 375a, 375b, and 375c (generally referred to as block data 375). The headers 320 may comprise metadata associated with their respective blocks 305. For example, the headers 320 may comprise a respective block number 325a, 325b, and 325c. As shown in FIG. 3, the block number 325a of the block 305a is N−1, the block number 325b of the block 305b is N, and the block number 325c of the block 305c is N+1. The headers 320 of the blocks 305 may include a data field comprising a block size (not shown).

The blocks 305 may be linked together and cryptographically secured. For example, the header 320b of the block N (block 305b) includes a data field (previous block hash 330b) comprising a hash representation of the previous block N−1's header 320a. The hashing algorithm utilized for generating the hash representation may be, for example, a secure hashing algorithm 256 (SHA-256) which results in an output of a fixed length. In this example, the hashing algorithm is a one-way hash function, where it is computationally difficult to determine the input to the hash function based on the output of the hash function. Additionally, the header 320c of the block N+1 (block 305c) includes a data field (previous block hash 330c) comprising a hash representation of block N's (block 305b) header 320b.

The headers 320 of the blocks 305 may also include data fields comprising a hash representation of the block data, such as the block data hash 370a-c. The block data hash 370a-c may be generated, for example, by a Merkle tree and by storing the hash or by using a hash that is based on all of the block data. The headers 320 of the blocks 305 may comprise a respective nonce 360a, 360b, and 360c. In some implementations, the value of the nonce 360a-c is an arbitrary string that is concatenated with (or appended to) the hash of the block. The headers 320 may comprise other data, such as a difficulty target.

The blocks 305 may comprise a respective block data 375a, 375b, and 375c (generally referred to as block data 375). The block data 375 may comprise a record of validated transactions that have also been integrated into the blockchain network 200 via a consensus model (described below). As discussed above, the block data 375 may include a variety of different types of data in addition to validated transactions. Block data 375 may include any data, such as text, audio, video, image, or file, that may be represented digitally and stored electronically. In some instances, blocks 305 may include a digital asset discussed above.

### Blockchain Transaction

In one example, a blockchain based transaction may generally involve a transfer of data or value or an interaction between entities and described in more detail below. Referring to FIG. 1, the first server 150 and/or the second server 152 may include one or more applications. An example application may be a transaction application configured to facilitate a blockchain transaction between entities. The entities may include entities 110, 115, devices, etc. In an example, first entity 110 may request or initiate a transaction with second entity 115 via an entity application executing on the client device 120. The transaction may be related to a transfer of value or data from the first entity 110 to the second entity 115. The value or data may represent money, a contract, a property, records, rights, status, supply, demand, an alarm, trigger, a digital asset, an NFT, or any other asset that may be represented in digital form.

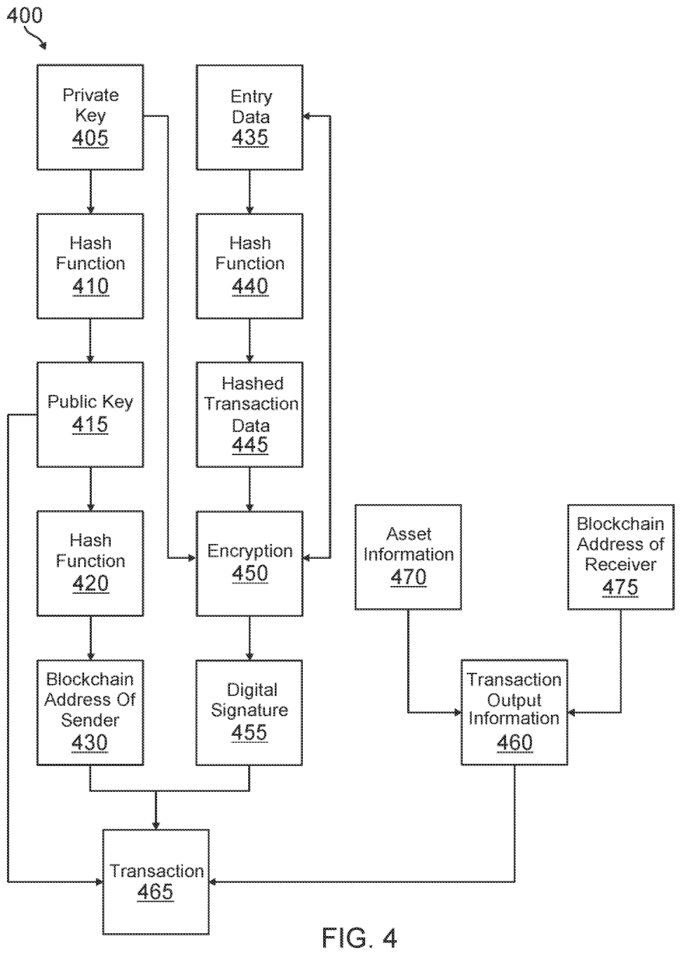

FIG. 4 is a block diagram 400 of a transaction generated by a transaction application, according to an embodiment. A transaction may be a transaction 465 that is performed between the first entity 110 and the second entity 115 of FIG. 1. In this example, transaction 465 may include a public key 415, a blockchain address 430 associated with first entity 110, a digital signature 455, and transaction output information 460. The transaction application may derive a public key 415 from a private key 405 of the first entity 110 by applying a cryptographic hash function 410 to the private key 405. The cryptographic hash function 410 may be based on AES. SHA-2. SHA-3, RSA, ECDSA, ECDH (elliptic curve cryptography), or DSA (finite field cryptography), although other cryptographic models may be utilized. More information about cryptographic algorithms may be found in Federal Information Processing Standards Publication (FIPS PUB 180-3). Secure Hash Standard.

The transaction application may derive an address or identifier for the first entity 110, such as the blockchain address 430, by applying a hash function 420 to the public key 415. Briefly, a hash function is a function that may be used for mapping arbitrary size data to fixed size data. The value may also be referred to as a digest, a hash value, a hash code, or a hash. In order to indicate that the first entity 110 is the originator of the transaction 465, the transaction application may generate the digital signature 455 for a transaction data 435 using the private key 405 of the first entity 110. The transaction data 435 may include information about the assets to be transferred and a reference to the sources of the assets, such as previous transactions in which the assets were transferred to the first entity 110 or an identification of events that originated the assets. Generating the digital signature 455 may include applying a hash function 440 to the transaction data 435 resulting in hashed transaction data 445. The hashed transaction data 445 and the transaction data 435 may be encrypted (via an encryption function 450) using the private key 405 of the first entity 110 resulting in the digital signature 455. The transaction output information 460 may include asset information 470) and an address or identifier for the second entity 115, such as the blockchain address 475. The transaction 465 may be sent from client device 120 of the first entity 110 to the first server 150.

The specific type of cryptographic algorithm being utilized may vary dynamically based on various factors, such as a length of time, privacy concerns, etc. For example, the type of cryptographic algorithm being utilized may be changed yearly, weekly, daily, etc. The type of algorithms may also change based on varying levels of privacy. For example, an owner of content may implement a higher level of protection or privacy by utilizing a stronger algorithm.

### Blockchain Addresses

Blockchain networks 130a-c may utilize blockchain addresses to indicate an entity using the blockchain or start and end points in the transaction. For example, a blockchain address for the first entity 110, shown in FIG. 4 as the blockchain address 430 of sender, may include an alphanumeric string of characters derived from the public key 415 of the first entity 110 based on applying a cryptographic hash function 420 to the public key 415. The methods used for deriving the addresses may vary and may be specific to the implementation of the blockchain network. In some examples, a blockchain address may be converted into a QR code representation, barcode, token, or other visual representations or graphical depictions to enable the address to be optically scanned by a mobile device, wearables, sensors, cameras, etc. In addition to an address or QR code, there are many ways of identifying individuals, objects, etc. represented in a blockchain. For example, an individual may be identified through biometric information such as a fingerprint, retinal scan, voice, facial id, temperature, heart rate, gestures/movements unique to a person etc., and through other types of identification information such as account numbers, home address, social security number, formal name, etc.

### Broadcasting Transaction

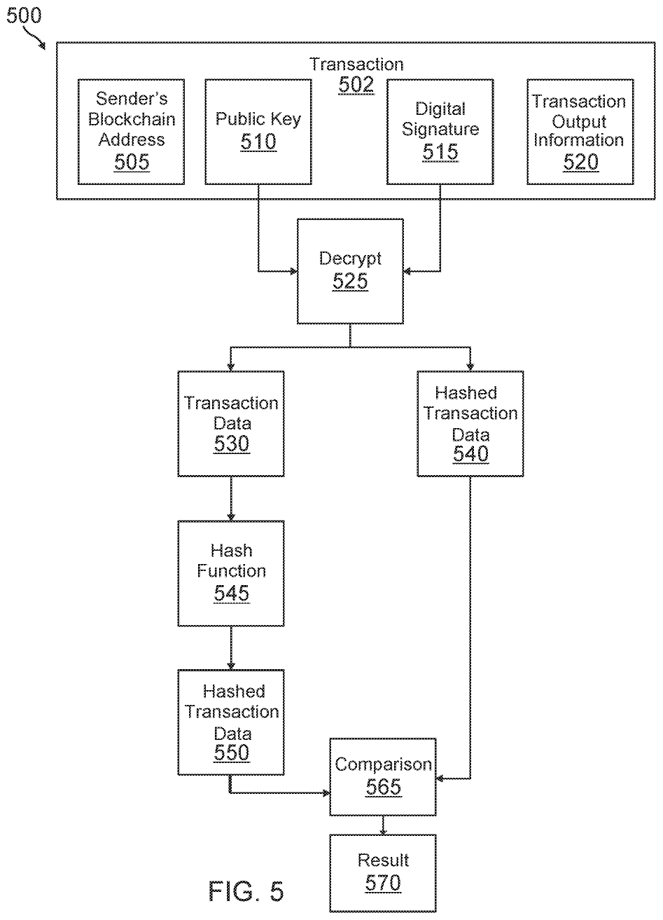

The first server 150 of FIG. 1 may receive transactions from entities of the blockchain network 130. The transactions may be submitted to the first server 150 via desktop applications, smartphone applications, digital wallet applications, web services, or other software applications that may execute on e.g., client device 120 or 125. The first server 150 may send or broadcast the transactions to the blockchain network 130. FIG. 5 is a diagram 500 showing an example transaction broadcasted by the first server 150 to the blockchain network 130, according to some embodiments. A transaction 502 may be broadcast to multiple nodes 205 of the blockchain network 130. Typically, once the transaction 502 is broadcasted or submitted to the blockchain network 130, it may be received by one or more of the nodes 205. Once the transaction 502 is received by the one or more nodes 205 of the blockchain network 130, it may be propagated by the receiving nodes 205 to other nodes 205 of the blockchain network 130.

Blockchain network 130 may operate according to a set of rules. The rules may specify conditions under which a node may accept a transaction, a type of transaction that a node may accept, a type of compensation that a node receives for accepting and processing a transaction, etc. For example, a node may accept a transaction based on a transaction history, reputation, computational resources, relationships with service providers, etc. The rules may specify conditions for broadcasting a transaction to a node. For example, a transaction may be broadcasted to one or more specific nodes based on criteria related to the node's geography, history, reputation, market conditions, docket/delay, technology platform. The rules may be dynamically modified or updated (e.g., turned on or off) to address issues such as latency, scalability, and security conditions. A transaction may be broadcast to a subset of nodes as a form of compensation to entities associated with those nodes (e.g., through receipt of compensation for adding a block of one or more transactions to a blockchain).

### Transaction Validation—Entity Authentication and Transaction Data Integrity

Not all the full nodes 205 of FIG. 2 may receive the broadcasted transaction 502 at the same time, due to issues such as latency. Additionally, not all of the full nodes 205 that receive the broadcasted transaction 502 may choose to validate the transaction 502. A node 205 may choose to validate specific transactions, for example, based on transaction fees associated with the transaction 502. The transaction 502 may include a blockchain address 505 for the sender, a public key 510, a digital signature 515, and transaction output information 520. The node 205 may verify whether the transaction 502 is legal or conforms to a pre-defined set of rules. The node 205 may also validate the transaction 502 based on establishing entity authenticity and transaction data integrity. Entity authenticity may be established by determining whether the sender indicated by the transaction 502 is in fact the actual originator of the transaction 502. Entity authenticity may be proven via cryptography, for example, asymmetric-key cryptography using a pair of keys, such as a public key and a private key. Additional factors may be considered when establishing entity authenticity, such as entity reputation, market conditions, history, transaction speed, etc. Data integrity of the transaction 502 may be established by determining whether the data associated with the transaction 502 was modified in any way. Referring back to FIG. 4, when the transaction application creates the transaction 465, it may indicate that the first entity 110 is the originator of the transaction 465 by including the digital signature 455, which is digital signature 515.

The node 205 may decrypt the digital signature 515 using the public key 510. A result of the decryption may include hashed transaction data 540 and transaction data 530. The node 205 may generate hashed transaction data 550 based on applying a hash function 545 to the transaction data 530. The node 205 may perform a comparison 565 between the first hashed transaction data 540) and the second hashed transaction data 550. If the result 570 of the comparison 565 indicates a match, then the data integrity of the transaction 502 may be established and node 205 may indicate that the transaction 502 has been successfully validated. Otherwise, the data of the transaction 502 may have been modified in some manner and the node 205 may indicate that the transaction 502 has not been successfully validated.

Each full node 205 may build its own block 305 and add validated transactions to that block. Thus, the blocks 305 of different full nodes 205 may comprise different validated transactions. As an example, a full node 205a may create a first block comprising transactions “A.” “B.” and “C.” Another full node 205b may create a second block comprising transactions “C.” “D.” and “E.” Both blocks may include valid transactions. However, only one block 305 may get added to the blockchain, otherwise the transactions that the blocks may have in common, such as transaction “C” may be recorded twice leading to issues such as double spending when a transaction is executed twice. One problem that may be seen with the above example is that transactions “C,” “D,” and “E” may be overly delayed in being added to the blockchain. This may be addressed a number of different ways as discussed below.

### Securing Keys

Private keys, public keys, and addresses may be managed and secured using software, such as a digital wallet. Private keys may also be stored and secured using hardware. The digital wallet may also enable the entity to conduct transactions and manage the balance. The digital wallet may be stored or maintained online or offline, and in software or hardware or both hardware and software in e.g., client devices 120 or 125 discussed in FIG. 1. Without the public/private keys, an entity has no way to prove ownership of assets. Additionally, anyone with access an entity's public/private keys may access the entity's assets. While the assets may be recorded on the blockchain, the entity may not be able to access them without the private key.

### Tokens

A token may refer to an entry in the blockchain that belongs to a blockchain address. The entry may comprise information indicating ownership of an asset. The token may represent money, a contract, a property, records, access rights, status, supply, demand, an alarm, a trigger, a reputation, a ticket, a digital asset, an NFT, or any other asset that may be represented in digital form. For example, a token may refer to an entry related to cryptocurrency that is used for a specific purpose or may represent ownership of a real-world asset, such as Fiat currency or real-estate. Token contracts refer to cryptographic tokens that represent a set of rules that are encoded in a smart contract. An entity, e.g., first entity 110 or second entity 115 that owns the private key corresponding to the blockchain address may access the tokens at the address. Thus, the blockchain address may represent an identity of the person that owns the tokens. Only the owner of the blockchain address may send the token to another person. The tokens may be accessible to the owner via the owner's wallet. The owner of a token may send or transfer the token to an entity via a blockchain transaction. For example, the owner may sign the transaction corresponding to the transfer of the token with the private key. When the token is received by the entity, the token may be recorded in the blockchain at the blockchain address of the entity.

### Establishing Entity Identity

While a digital signature may provide a link between a transaction and an owner of assets being transferred, it may not provide a link to the real identity of the owner. In some cases, the real identity of the owner of the public key corresponding to the digital signature may need to be established. The real identity of an owner of a public key may be verified, for example, based on biometric data, passwords, personal information, etc. Biometric data may comprise any physically identifying information such as fingerprints, face and eye images, voice sample, DNA, human movement, gestures, gait, expressions, heart rate characteristics, temperature, etc.

The entities that run a full node 205, build blocks 305 and/or add validated transactions to blocks 305 may be called miners. In some embodiments, the digital signature of a miner or a public key of the miner may be used to establish the identity of the miner of block 305 that includes a transaction from a payment provider, such as Pay Pal™.

### Publishing and Validating a Block

As discussed above, full nodes 205 may each build their own blocks that include different transactions. A node may build a block by adding validated transactions to the block until the block reaches a certain size that may be specified by the blockchain rules. However, only one of the blocks may be added to the blockchain. The block to be added to the blockchain and the ordering of the blocks may be determined based on a consensus model. In a proof of work model, both nodes may compete to add their respective block to the blockchain by solving a complex mathematical puzzle. For example, such a puzzle may include determining a nonce, as discussed above, such that a hash (using a predetermined hashing algorithm) of the block to be added to the blockchain (including the nonce) has a value that meets a range limitation. If both nodes solve the puzzle at the same time, then a “fork” may be created. When a full node 205 solves the puzzle, it may publish its block to be validated by the validation nodes 205 of the blockchain network 130.

In a proof of work consensus model, node 205 validates a transaction, for example, by running a check or search through the current ledger stored in the blockchain. The node 305 will create a new block for the blockchain that will include the data for one or more validated transactions (e.g., block data 375 of FIG. 3). In a blockchain implementation such as Bitcoin, the size of a block is constrained. Referring back to FIG. 3, in this example, the block 305 will include a previous block hash 330 representing a hash of what is currently the last block in the blockchain. The block 305 may also include a hash 370 of its own transaction data (e.g., a so-called Merkle hash). According to a particular algorithm, all or selected data from the block 305 may be hashed to create a final hash value.

According to an embodiment of the proof of work model, the node 205 will seek to modify the data of the block 305 so that the final hash value is less than a preset value. This is achieved through addition of a data value referred to as a nonce 360. Because final hash values cannot be predicted based on its input, it is not possible to estimate an appropriate value for the nonce 360 that will result in a final hash value that is less than the pre-set value. Accordingly, a computationally intensive operation may be needed at the node 205 to determine an appropriate nonce value through a “brute force” trial-and-error method. Once a successful nonce value is determined, the completed block 305 is published to the blockchain network 220 for validation. If validated by a majority of the nodes in the blockchain network 220, the completed block 350 is added to the blockchain 220 at each participating node 205. When a node's block is not added to the blockchain 220, the block 305 is discarded and the node 205 proceeds to build a new block. The transactions that were in the discarded block may be returned to a queue and wait to be added to a next block. When a transaction is discarded or returned to the queue, the assets associated with the discarded transaction are not lost, since a record of the assets will exist in the blockchain 220. However, when a transaction is returned to the queue, it causes a delay in completing the transaction.

Reducing the time to complete a transaction may be important. A set of blockchain rules, or renumeration/compensation for a node 205 to process the returned transaction may determine how a returned transaction is to be treated going forward. When a transaction is put into a queue then it can have a priority level but then a rule may indicate that the transaction priority level must exceed a threshold level. The priority level of a returned or discarded transaction may be increased. Another way to reduce the time to complete a transaction is to have the system, service provider, participant in the transaction, or merchant pay additional incentive 205 for nodes to process a returned or discarded transaction. As an example, a service provider may identify a network of preferred miners based on geography, energy mix or based on a volume discount perspective. The time to complete a transaction may be optimized by routing a returned transaction to specific preferred nodes 205. A transaction may be associated with an address that limits which of the preferred nodes 205 may process the transaction if the transaction is returned due to its inclusion in a discarded block. A value may be associated with the transaction so that it is routed to preferred miners in a specific geographic location.

### Blockchain Confirmations

After block 305 comprising a transaction is added to blockchain 220, a blockchain confirmation may be generated for the transaction. The blockchain confirmation may be a number of blocks added to the blockchain 220) after the block that includes the transaction. For example, when a transaction is broadcasted to the blockchain 220, there will be no blockchain confirmations associated with the transaction. If the transaction is not validated, then the block 305 comprising the transaction will not be added to the blockchain 220 and the transaction will continue to have no blockchain confirmations associated with it. However, if block 305 comprising the transaction is validated, then each of the transactions in the block will have a blockchain confirmation associated with the transaction. Thus, a transaction in block 305 will have one blockchain confirmation associated with it when the block 305 is validated. When the block 305 is added to the blockchain 220, each of the transactions in the block 305 will have two blockchain confirmations associated with it. As additional validated blocks are added to the blockchain 220, the number of blockchain confirmations associated with the block 305 will increase. Thus, the number of blockchain confirmations associated with a transaction may indicate a difficulty of overwriting or reversing the transaction. A higher valued transaction may require a larger number of blockchain confirmations before the transaction is executed.

### Consensus Models

As discussed above, blockchain network 130 may determine which of the full nodes 205 publishes a next block to the blockchain 220. In a permissionless blockchain network 130, the nodes 205 may compete to determine which one publishes the next block. A node 205 may be selected to publish its block 305 as the next block in the blockchain 220 based on consensus model. For example, the selected or winning node 205 may receive a reward, such as a transaction fee, for publishing its block, for example. Various consensus models may be used, for example, a proof of work model, a proof of stake model, a delegated proof of stake model, a round robin model, proof of authority or proof of identity model, and proof of elapsed time model.

In a proof of work model, node 205 may publish the next block 305 by being the first to solve a computationally intensive mathematical problem (e.g., the mathematical puzzle described above). The solution serves as “proof” that the node 205 expended an appropriate amount of effort in order to publish the block 305. The solution may be validated by the full nodes before the block 305 is accepted. The proof of stake model is generally less computationally intensive than the proof of work model. Unlike the proof of work model which is open to any node 205 having the computational resources for solving the mathematical problem, the proof of stake model is open to any node 205 that has a stake in the system. The stake may be an amount of cryptocurrency that the node 205 may have invested into the system. The likelihood of node 205 publishing the next block may be proportional to its stake. Since this model utilizes fewer resources, the blockchain 220 may forego a reward as incentive for publishing the next block 305. The round robin model is generally used by permissioned blockchain networks 130. Using this model, nodes 305 may take turns to publish new blocks 305. In the proof of elapsed time model, each publishing node requests a wait time from a secure hardware within their computer system. The publishing node may become idle for the duration of the wait time and then creates and publishes a block to the blockchain network. As an example, in cases where there is a need for speed and/or scalability (e.g., in the context of a corporate environment), a hybrid blockchain network 130 may switch to be between completely or partially permissioned and permissionless. The blockchain network 130 may switch based on various factors, such as latency, security, market conditions, etc.

### Smart Contracts

A smart contract is a set of instructions executable on a peer node 205 (that may include terms for execution) that is stored in blockchain 220 and automatically executed when the agreement's predetermined terms and conditions are met. The terms and conditions of the agreement may be visible to other users of the blockchain 220. When the pre-defined rules are satisfied, then the relevant code is automatically executed. The agreement may be written as a script using a programming language such as Java, C++, JavaScript, VBScript, HyperText Preprocessor (PHP), Perl, Python, Ruby, Active Server pages (ASP), Tcl, etc. The script may be uploaded to the blockchain as a transaction on the blockchain.

As an example, first entity 110 of FIG. 1 may create a smart contract to sell a digital asset (e.g., NFT) to the second entity 115. A smart contract, which may be a peer executable set of instructions, and may be utilized between the first entity 110 and the second entity 115 for sale of the digital asset.

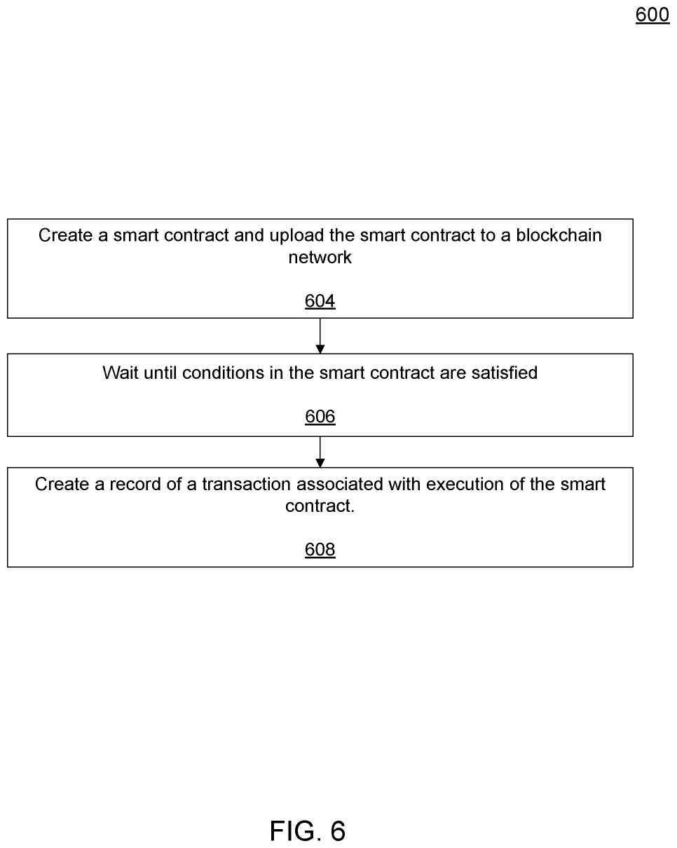

FIG. 6 is a flowchart of a method 600 for performing a smart contract transaction created by the verification system 155 on the blockchain network 130, according to an embodiment. The steps of the method 600 may be performed by any of the computing devices shown in FIG. 1. Alternatively, or additionally, some or all of the steps of the method 600 may be performed by one or more other computing devices. Steps of the method 600 may be modified, omitted, and/or performed in other orders, and/or other steps added.

At step 602, a smart contract is created and uploaded to blockchain. For example, smart contract that incentivizes miners may be created and then submitted to the blockchain network 130a as a transaction. The transaction may be added to a block 305 that is mined by the nodes 205 of the blockchain network 130a. The block 305 comprising the transaction may be validated by the blockchain network 130a and then recorded in the blockchain 220. The smart contract associated with the transaction may be given a unique address for identification.

At step 604, the node 205 may wait until conditions in the smart contract are satisfied. An example condition may be whether a blockchain transaction was mined by a green miner. A green miner may be an entity that includes a certain percentage of green energy in the mix of energy resources, a combination of different types of green energy, or a predefined amount of green energy. Green energy may be energy collected from renewable resources, such as sunlight, wind, water movement, geothermal heat, and the like.

At step 606, the node 205 may create a record of a transaction associated with execution of the smart contract. For example, the transaction may release an incentive, a percentage of the inventive, or a predefined amount of the incentive to the green miner.

### Blockchain-Based Application: Incentive Smart Contract

Going back to FIG. 1, an incentive smart contract is a token that may be created and stored electronically in a blockchain, such as a the blockchain network 130a in FIG. 1. As discussed above, a smart contract is a set of instructions that are executable by a peer while mining a new block 305. In some embodiments, the smart contracts are stored as tokens on the blockchain network 130a in FIG. 1. Tokens may be created with data, such as public key associated with miners, including the green miners, that may be incentivized for adding blocks 305 to blockchain 220 using green energy or a mix of green energy.

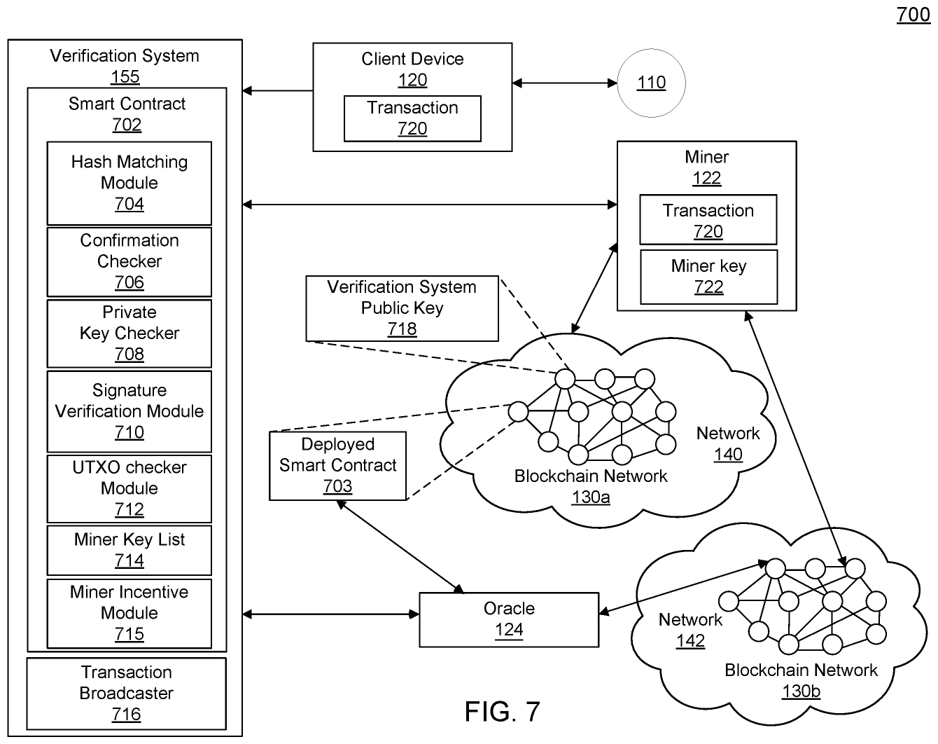

FIG. 7 is a diagram 700 of an environment that provides a decentralized mechanism to incentivize green bitcoin miners, according to some embodiments. Verification system 155 shown in FIG. 7 may include a transaction broadcaster 716 that may be picked up by a miner 122 for including in a new block on the blockchain network 130a or 130b. Verification system 155 may generate a broadcast message requesting the transaction 720 be deployed on a blockchain network 130b. In some embodiments, the blockchain network 130a and 130b may be or may not be the same network. In an embodiment, blockchain network 130a may be a smart contract enabled blockchain network and 130b may be a bitcoin blockchain network. Blockchain network 130a may be included in network 140 and blockchain network 130b may be included in network 142. Network 140 and network 142 may be the same or different networks discussed in FIG. 1.

Miner 122 may be a node 205 (shown in FIG. 2) in the blockchain network 130a that collects and processes the transactions for inclusion in a new block 305 of the blockchain 220. Miner 122 may mine bitcoins on the blockchain network 130a, 130b, or both that stores bitcoins. In some embodiments, blockchain network 130a, 130b, or both may use different blockchain protocols.

Verification system 155 may generate a smart contract 702 that may be deployed on the blockchain network 130a that provides a decentralized mechanism to incentivize green miners 122, according to some embodiments. Verification system 155 may process transactions, such as transaction 720 originally sent from a client device 120.

The smart contract 702 may include modules such as hash matching module 704, confirmation checker 706, private key checker 708, signature verification module 710, unpaid transaction output (UTXO) checker module 712, miner key list 714, miner incentive module 715 and the like. The smart contract 702 may be deployed on the blockchain network 130a via the miner 122. The smart contract 702 deployed on the blockchain network 130a is shown as a deployed smart contract 703. The deployed smart contract 703 includes the same modules as the smart contract 702. The functionality of the instructions in the modules of smart contract 702 and deployed smart contract 703 may be identical.

Verification system 155 may include transaction broadcaster 716 for broadcasting messages. The miner 122 may receive a transaction request from transaction broadcaster 716 to place the transaction 720 on a new block in the blockchain network 130b. Verification system 155 may receive transaction 720 from client device 120. The transaction broadcaster 716 may include the transaction 720 to be placed on the blockchain 130a or 130b and an unpaid transaction output that is addressed to the verifications system public key 718. Since the verifications system public key 718 belongs to the verification system 155, there is no spending on the part of the verifications system 155. Smart contract 702 may use the unpaid transaction output to verify whether a block on the blockchain 130a or 130b has a transaction, such as transaction 720, that was broadcast by the verification system 155.

Miner 122 may mine the blockchain network 130b. The miner 122 may use a miner key pair that includes a public-private key pair to generate a hash of the transaction that is mined on the blockchain network 130b. In some embodiments, the miner 122 may sign the hash of the block the miner 122 mines using the public key of the public-private key pair of the miner 122. Miner 122 may be a green miner.

Deployed smart contract 703 may interact with the external world through an oracle 124 or another interface configured to communicate with blockchain networks 130a and 130b. Oracle 124 may be an Application Programing Interface (API) executing on a computing device. Oracle 124 may interact with the verification system 155, other resources, blockchains and computing devices in the environment in FIG. 7. Oracle 124 provides the deployed smart contract 703 with information, such as blocks from the blockchain network 130a, or 130b, updated miner key list 714 from the verification system 155 and the like. Oracle 124 may be a Chainlink™.

The hash matching module 704 may match hashes of transactions to verify whether they are the same transaction. For example, the miner 122 may send a hash to the smart contract 702 that was newly mined. The hash matching module 704 allows the miner 122 to verify that the hash is identical to the hash on the blockchain network 130a.

The confirmation checker 706 may provide confirmation that a block on the blockchain say 130b has enough confirmation that is consistent with the specification of the blockchain 130b. Confirmation specifications are designed to prevent dead forks of the blockchain 130b. Confirmation specification are also designed to avoid loss of the bitcoins or digital assets.

The private key checker 708 may check if a key received at deployed smart contract 703 matches a key in the miner key list 714. For example, the miner 122 may send the miner public key to the smart contract 702 once the transaction 720 is mined on the blockchain network 130b to identify the miner 122.

The signature verification module 710 may check the signature of the hash received from the miner 122. For example, miner 122 may verify the signature on the hash of the transaction to verify it was signed using the miner key pair.

The UTXO checker module 712 allows the smart contract 702 to check whether the block number received from the miner 122 has a transaction from the verification system 155. The miner 122 may mine a block having a particular block number on the blockchain 130b. The miner 122 may transmit the block number to the smart contract 702 to allow the smart contract 702 to verify the transaction on the blockchain 130b.

Verification system 155 while generating the smart contract 702 may include miner key list 714. Miner key list 714 is a list of miners 122 that are preferred to mine the transaction 720 on blockchain network 130b. Verification system 155 may incentivize miners 122 based on the mix of energy used to mine the blockchain 130a. For example, some miners 122 may be green miners because these miners 122 may use more than a predefined percentage of renewable energy resources or a mix of energy resources to mine the blockchain 130a. The green miners may be incentivized using the embodiments described herein.

Verification system 155 may include miner incentive module 715 in the smart contract 702. Miner incentive module 715 may provide miners that are on the miner key list 714 with an incentive after verification that a block with the transaction in the transaction request was mined on the blockchain network 130b.

### Blockchain Enabled Miner Incentives

In an embodiment, the transaction broadcaster 716 when broadcasting the transaction 720 from client device 120 may add another UTXO. The UTXO may pay “N” number of Bitcoins to a public key verification system public key 718 that belongs to the verification system 155. An example verification system public key 718 may be “PKpaypal” and an example verification system 155 may be operated by Pay Pal™. The number of bitcoins that are paid may be based on a spoofing threshold. The spoofing threshold may be set based on the number of Bitcoins that may deter an attempt to send a spoofed UTXO to trigger mining from the incentivized miners by forcing the attackers to send the bitcoin to the verification system public key. Sending bitcoins to the verification system public key 718 does not result in spending for the verification system 155 because the transaction is an internal transaction. However, an attacker has to pay to the verification system public key address which incurs a cost, thereby disincentivizing the spoofer.

In some embodiments, miner 122 may be incentivized to create the miner key pair. For example, green miners may create a special purpose public-private key pair, such as PKgreen. Miner 122 may use the PKgreen keys in the private-public key pair to sign the hash of the block 305 that the miner 122 may mine.

In some embodiments, when miner 122 detects an on-chain transaction with a UTXO that pays to the verification system public key 718 (e.g., PKpaypal), miner 122 may know that the transaction 720 is associated with verification system 155 and may include transaction 720 in the block miner 122 mines. Miner 122 may also record one or more of the block number, hash of the block, and the signature of the hash which was signed using the miner keychain PKgreen in a message sent to deployed smart contract 703.

In some embodiments, when the block 305 is accepted by the blockchain network 130a and has enough confirmations, the miner 122 (e.g., green miner) which mined the block 305 may feed the following information to a smart contract 702: miner key (e.g., PKgreen), block number miner 122 mined that includes the transaction 720, hash of the block 305 that includes the transaction 720 and a signature of the hash signed using the miner key (e.g., PKgreen).

In some embodiments, the verification system 155 may be used with any smart contract enabled blockchain, such as Ethereum, Solana etc. Verification system 155 may lock some miner incentive, such as native tokens in the miner incentive module 715. The smart contract 702 may pay the miner incentive to the green miners later on. Smart contract 702 may also include miner key list 714 (e.g., public keys that contains multiple PKgreen keys created as described above) that are associated with miners 122 and that verification system 155 recognizes as green miners.

In some embodiments, after receiving inputs from the miner 122, smart contract 702 may query blockchain network 130b through decentralized oracles 124 or other interfaces to fetch the corresponding block. For example, the blockchain network 130b may be a Bitcoin™ blockchain network.

In some embodiments, smart contract 702 may verify via the hash matching module 704 that the hash of the block matches the hash received from the miner 122. Smart contract 702 may also verify via the confirmation checker 706 that the block 305 has enough confirmations. Smart contract 702 may also verify via the private key checker 708 that the miner key (e.g., PKgreen) received from the miner 122 is in the miner key list 714 on the smart contract 702.

In some embodiments, smart contract 702 may determine whether the signature provided by the miner 122 is valid. The smart contract 702 may determine whether the block contains at least one transaction that pays to verification system public key 718.

In some embodiments, the smart contract 702 may pay a predefined percentage of the miner incentive locked in miner incentive module 715 of the smart contract 702 to the corresponding miner 122 that mined the block.

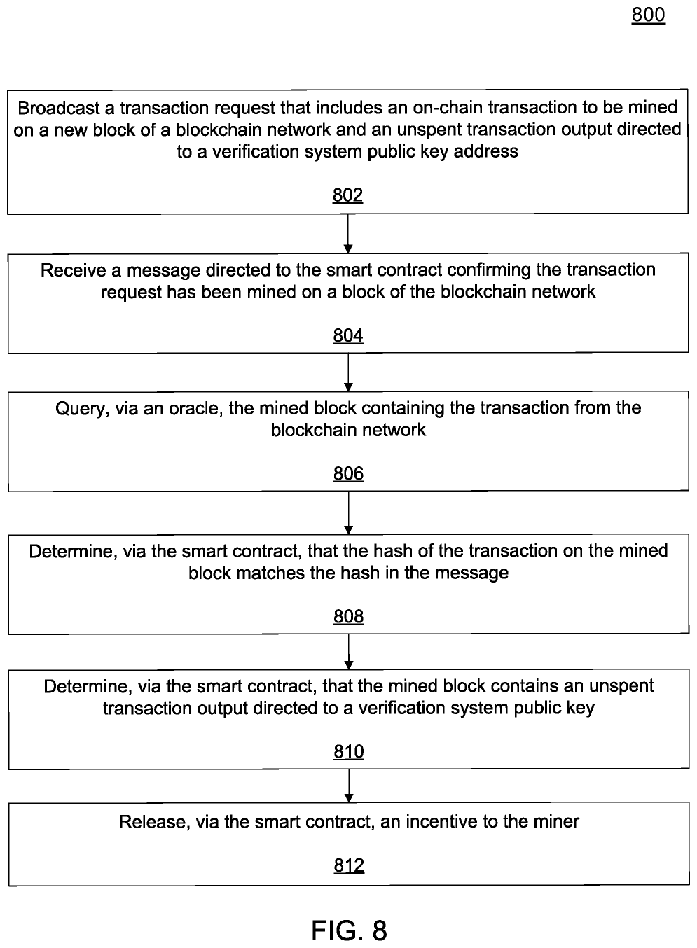

FIG. 8 is a flow diagram of a method 800 for decentralized incentivizing a miner for a transaction on a blockchain, according to some embodiments. An example transaction may be between entities, such as the client device 120, the verification system 155 and the miner 122. Method 800 may be performed by the computing devices, or a combination of computing devices shown in FIGS. 1-7. Steps 802-812 of method 800 may be modified, omitted, and/or performed in other orders, and/or other steps added. Verification system 155 may broadcast transaction request which includes an on-chain transaction 720 to be mined on a new block of a blockchain network 130b and an unspent transaction output directed to a verification system public key 718. In an embodiment, the transaction broadcaster 716 when broadcasting the transaction 720 from client device 120 may add another UTXO that may pay “N” number of Bitcoin to a public key verification system public key address” that belongs to the verification system 155.

At step 802, a transaction request is broadcasted. For example, the verification system 155 may broadcast a transaction request that includes an on-chain transaction to be mined on block 305 of the blockchain network 130b and an unspent transaction output directed to a verification system public key 718.

At step 804, a message confirming a transaction has been mined is received. For example, the smart contract 702 may receive a message confirming the transaction 720 has been mined on a block of the blockchain network 130b. The message may include at least one of a public key 722 of a miner 122, a block number mined, a hash of the block, and a digital signature. For exemplary purposes, miner 122 may be a green miner using green energy or a mix of green energy to mine a block to blockchain network 130b.

At step 806, a mined block is queried. For example, oracle 124 or another interface may query the mined block containing the transaction 720 from the blockchain network 130a.

At step 808, the smart contract 702 may determine whether the hash of the transaction on the mined block matches the hash in the message received from the miner 722.

At step 810, the smart contract 702 may determine that the mined block contains an unspent transaction output directed to a verification system 155 public key.

At step 812, miner incentive is released. For example, miner incentive module 715 of the smart contract 702 may release a miner incentive to the miner 122.

FIG. 9 is a block diagram of a computer system 900 suitable for implementing one or more components or methods in FIGS. 1-8, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by entities and service providers may be implemented as computer system 900 in a manner as follows.

Computer system 900 includes a bus 902 or other communication mechanism for communicating information data, signals, and information between various components of computer system 900. Components include an input/output (I/O) component 904 that processes an entity action, such as selecting keys from a keypad/keyboard, selecting one or more buttons, image, or links, and/or moving one or more images, etc., and sends a corresponding signal to bus 902. I/O component 904 may also include an output component, such as a display 911 and a cursor control 913 (such as a keyboard, keypad, mouse, etc.). An optional audio input/output component 904 may also be included to allow an entity to use voice for inputting information by converting audio signals. Audio I/O component 905 may allow the entity to hear audio. A transceiver or network interface 906 transmits and receives signals between computer system 900 and other devices, such as another communication device, service device, or a service provider server via a network, such as network 140 and/or 142 of FIGS. 1, 2, and/or 7. In one embodiment, the transmission is wireless, although other transmission mediums and methods may also be suitable. One or more processor(s) 912, which can be a micro-controller, digital signal processor (DSP), or other processing component, processes these various signals, such as for display on computer system 900 or transmission to other devices via a communication link 918. Processor(s) 912 may also control transmission of information, such as cookies or IP addresses, to other devices.

Components of computer system 900 also include a system memory component 914 (e.g., RAM), a static storage component (e.g., ROM), and/or a disk drive 917. Computer system 900 performs specific operations by processor(s) 912 and other components by executing one or more sequences of instructions contained in system memory component 914. Logic may be encoded in a computer readable medium, which may refer to any medium that participates in providing machine-readable instructions to processor(s) 912 for execution. Such a medium may take many forms, including but not limited to, non-volatile media, volatile media, and transmission media. In various embodiments, non-volatile media includes optical or magnetic disks, volatile media includes dynamic memory, such as system memory component 914, and transmission media includes coaxial cables, copper wire, and fiber optics, including wires that comprise bus 902. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 900. In various other embodiments of the present disclosure, a plurality of computer systems 900 coupled by communication link 918 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A verification system comprising:
a non-transitory memory; and
one or more hardware processors coupled to the non-transitory memory and configured to read instructions from the non-transitory memory to cause the verification system to perform operations comprising:
broadcasting a transaction request, wherein the transaction request includes an on-chain transaction to be mined on a block of a blockchain network:
receiving a message directed to a smart contract that the transaction in the transaction request has been mined on the block of the blockchain network:
querying, via an oracle, the block containing the transaction from the blockchain network:
determining, via the smart contract, that a hash of the transaction on the block matches the hash in the message:
determining, via the smart contract, that a public key of a miner matches a list of incentivized keys stored on the smart contract; and
releasing an incentive to the miner of the block.

2. The verification system of claim 1, wherein the transaction request further comprises an unspent transaction output directed to a verification system public key, wherein the unspent transaction output is based on a spoofing threshold.

3. The verification system of claim 1, wherein the message includes one or more of a public key of the miner, a block number of the mined block, a hash of the block and a digital signature.

4. The verification system of claim 3, wherein the operations further comprise:
determining whether the digital signature in the message is valid.

5. The verification system of claim 3, wherein the operations further comprise:
verifying that at least one transaction on the block is directed to a verification system public key.

6. The verification system of claim 3, wherein the operations further comprise:
determining that the block has a number of confirmations above a confirmation threshold.

7. The verification system of claim 1, wherein the list of incentivized keys is a list of public keys of green miners that use an energy mix to mine blocks to the blockchain network that includes renewable energy.

8. A method comprising:
broadcasting a transaction request, wherein the transaction request includes an on-chain transaction to be mined on a block of a blockchain network and an unspent transaction output directed to a verification system public key:
receiving a message directed to a smart contract that the transaction in the transaction request has been mined on the block of the blockchain network:
querying, via an oracle, the block containing the transaction from the blockchain network:
determining, via the smart contract, that a hash of the transaction on the block matches the hash in the message:
determining, via the smart contract, that the mined block contains the unspent: transaction output directed to the verification system public key; and
releasing an incentive to a miner of the block.

9. The method of claim 8, wherein the unspent transaction output is based on a spoofing threshold.

10. The method of claim 8, wherein the message includes one or more of a public key of the miner, a block number of the mined block, a hash of the block and a digital signature.

11. The method of claim 10, wherein the hash of the block is signed using the one or more of the public key of the miner, wherein the one or more of the public key is a green key.

12. The method of claim 10, further comprising:
determining that the digital signature in the message is valid.

13. The method of claim 10, further comprising:
verifying that at least one transaction on the block corresponds to a transaction output that is addressed to the verification system public key.

14. The method of claim 10, further comprising:
determining that the mined block has a number of confirmations above a confirmation threshold.

15. The method of claim 10, wherein the smart contract includes an incentivized keys list of green miners, wherein the green miners use an energy mix that includes renewable energy to mine blocks on the blockchain network.

16. A non-transitory computer readable medium having instructions stored thereon, that when executed by a processor cause the processor to perform operations, the operations comprising:
receiving a message directed to a smart contract that a transaction has been mined on a block of a blockchain network:
querying, via an application programming interface, the block containing the transaction from the blockchain network for a hash of the block:
determining, via the smart contract, that the hash of the block containing the transaction matches the hash of the block in the message:
determining, via the smart contract, that a public key of a miner matches a list of incentivized keys stored on the smart contract; and
releasing an incentive to the miner of the block.

17. The non-transitory computer readable medium of claim 16, further comprising:
broadcasting a transaction request, wherein the transaction request includes the transaction mined on the block of the blockchain network and an unspent transaction output directed to a verification system public key.

18. The non-transitory computer readable medium of claim 16, wherein the message includes one or more of a public key of the miner, a block number of the block, the hash of the block and a digital signature.

19. The non-transitory computer readable medium of claim 18, wherein the operations further comprise:
determining that the block having the block number includes the transaction on the blockchain network.

20. The non-transitory computer readable medium of claim 16, wherein the list of incentivized keys is a list of public keys of green miners that use an energy mix to mine blocks to the blockchain network that includes renewable energy.
